(19) United States
(12) Patent Application Publication
(10) Pub. No.: US 2012/0169629 A1
(43) Pub. Date: Jul. 5, 2012

(54) Display panel and operation method thereof

(75) Inventors: Wen-Kai Shih, Hsin-Chu (TW); Chung-Hung Chen, Hsin-Chu (TW); Sheng-Liang Hsieh, Hsin-Chu (TW)

(73) Assignee: AU OPTRONICS CORP, Hsinchu (TW)

(21) Appl. No.: 13/165,952

(22) Filed: Jun. 22, 2011

(30) Foreign Application Priority Data
Dec. 30, 2010 (TW) 099147049

(51) Int. Cl. G06F 3/041

(52) U.S. Cl. 345/173

(57) ABSTRACT

A display panel comprises a plurality of scan lines, a plurality of data lines and a plurality of display pixels. The scan lines are enabled for a corresponding scan period in sequence. Each of the display pixels is electrically coupled to a corresponding scan line and a corresponding data line respectively, and each of the display pixels is controlled by the corresponding scan line to determine whether receiving data provided from the corresponding data line. At least one of the display pixels is also used as a touch pixel. The scan period is divided into a touch period and a display period. A data line corresponding to the touch pixel provides touch-charging data to the touch pixel in the touch period, and provides image-displaying data to the touch pixel in the display period.

### TECHNICAL FIELD

The disclosure relates to a display panel and an operation method thereof, and more particularly to a display panel with touch function and an operation method thereof.

### BACKGROUND

With the rapid development of the science and technology, the flat-panel display apparatus (such as, the liquid crystal display apparatus) has many advantages, such as high image quality, little size, light weight and wide application-range, etc., thus it is widely applied into various consumer electronics products, such as mobile phone, notebook computer, desktop display apparatus and television, etc., and has gradually substituted the conventional cathode ray tube (CRT) display apparatus to be a main trend of the display apparatus.

The touch panel is a new human-machine interface, and is intuitional and fitted with the human nature in use. The touch panel may be integrated with the flat-panel display apparatus to make the flat-panel display apparatus be with the touch function, and it is an application trend for the development of the flat-panel display apparatus.

The conventional touch device applied into the flat-panel display apparatus needs a specialized driving module to provide pulse signals with high potential to drive touch units, and employs a specialized detecting module to judge whether a corresponding touch unit is touched. Therefore, the resolution of the conventional touch device is limited in the driving capability of the driving module and the amount of pins of the detecting module.

### SUMMARY OF DISCLOSURE

The disclosure provides a display panel, which comprises a plurality of scan lines, a plurality of data lines and a plurality of display pixels. The scan lines are enabled for a corresponding scan period in sequence. Each of the display pixels is electrically coupled to a corresponding one of the scan lines and a corresponding one of the data lines respectively, and each of the display pixels is controlled by the corresponding one of the scan lines to determine whether receiving data provided from the corresponding one of the data lines. At least one of the display pixels is also used as a touch pixel for performing a touch-detecting operation. The scan period is divided into a touch period and a display period. A data line corresponding to the touch pixel provides touch-charging data to the touch pixel in the touch period for generating a corresponding touch-detecting signal, and provides image-displaying data to the touch pixel in the display period. The corresponding touch-detecting signal generated by the touch-charging data in the touch-detecting period is configured for judging whether the touch pixel is touched.

In an exemplary embodiment of the disclosure, all of the display pixels are also used as touch pixels for performing the touch-detecting operation. Alternatively, some of the display pixels are also used as touch pixels for performing the touch-detecting operation.

In an exemplary embodiment of the disclosure, the touch period is before the display period. Alternatively, the touch period is after the display period.

In an exemplary embodiment of the disclosure, the display panel further comprises a touch-detecting circuit. The touch-detecting circuit reads out the corresponding touch-detecting signal through the touch data line for judging whether the corresponding touch pixel is touched. Alternatively, the touch-detecting circuit reads out the corresponding touch-detecting signal through a corresponding readout line for judging whether the corresponding touch pixel is touched.

The disclosure also provides an operation method for a display panel. The display panel comprises at least one pixel and at least one data line. The pixel is used for performing both of a displaying operation and a touch-detecting operation, and the at least one data line corresponds to the at least one pixel respectively. The operation method comprises: providing touch-charging data to the pixel through the data line for performing the touch-detecting operation to generate a corresponding touch-detecting signal in a touch period of a scan period when the pixel is turned on; detecting the corresponding touch-detecting signal to judge whether the pixel is touched after providing the touch-charging data; and providing image-displaying data to the pixel through the data line in a display period of the scan period, such that the pixel displays a result corresponding to the image-displaying data.

In an exemplary embodiment of the disclosure, the touch period and the display period are both a half of the scan period.

The display panel and the operation method of the disclosure employ the source driver to provide the touch-charging data to the corresponding touch pixels through the corresponding data lines, and it will not dispose a specific driving module and driving lines to provide the touch-charging data, thus the circuit of the disclosure is simple, and can reduce the related signal interference. Furthermore, since the driving capability of the source driver is powerful, the disclosure may design more touch pixels, and the maximum amount of the touch pixels may reach the amount of the display pixels of the whole display panel. That is, all of the display pixels of the display panel of the disclosure may be not only used as the display pixels for performing the displaying operation, but also used as the touch pixels for performing the touch-detecting operation.

### BRIEF DESCRIPTION OF THE DRAWINGS

The above objects and advantages of the disclosure will become more readily apparent to those ordinarily skilled in the art after reviewing the following detailed description and accompanying drawings, in which:

FIG. 1 is a schematic view of a display panel in accordance with an exemplary embodiment of the disclosure.

FIG. 2 is a schematic view of a circuit, in which is the display panel as shown in FIG. 1 applied.

FIG. 3 is a time-sequence view of various signals of the display panel as shown in FIG. 1.

FIG. 4 is a flow chart of an operation method of a display panel in accordance with another exemplary embodiment of the disclosure.

FIG. 5 is a circuit schematic view of performing a touch-detecting operation and reading out touch-detecting signals in accordance with other exemplary embodiment of the disclosure.

### DETAILED DESCRIPTION OF PREFERRED EMBODIMENTS

The disclosure will now be described more specifically with reference to the following embodiments. It is to be noted that the following descriptions of preferred embodiments of this invention are presented herein for purpose of illustration and description only. It is not intended to be exhaustive or to be limited to the precise form disclosed.

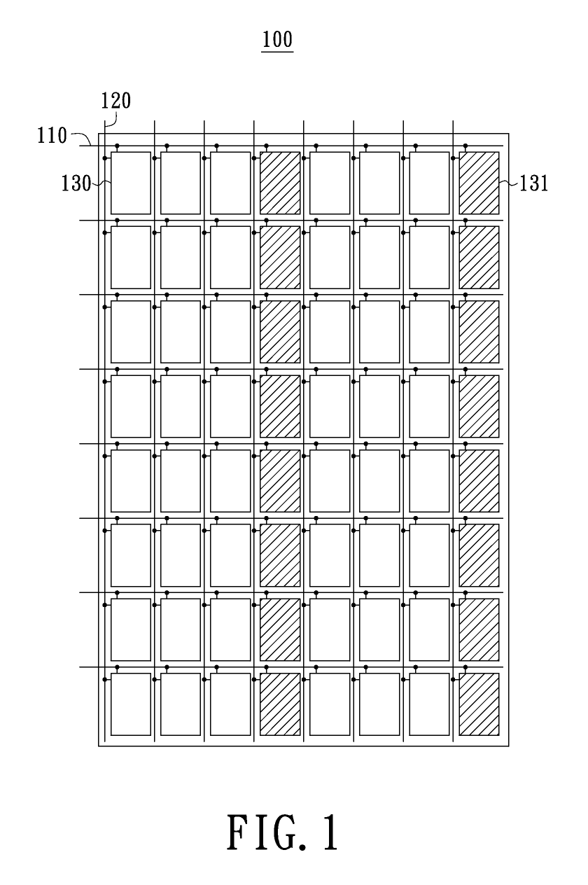

FIG. 1 is a schematic view of a display panel in accordance with an exemplary embodiment of the disclosure. Referring to FIG. 1, the display panel 100 of the exemplary embodiment comprises a plurality of scan lines 110, a plurality of data lines 120 and a plurality of display pixels 130. Each of the display pixels 130 is electrically coupled to a corresponding one of the scan lines 110 and a corresponding one of the data lines 120 respectively, such that each of the display pixels 130 is controlled by a scan signal of the corresponding one of the scan lines 110 to determine whether receiving image-displaying data transmitted from the corresponding one of the data lines 120, for displaying a corresponding image on the display panel 100.

In detail, it is understood for persons skilled in the art that, if the display panel 100 is a liquid crystal display (LCD) panel, each of the display pixels 130 is generally consisted of a corresponding pixel electrode, a common electrode and liquid crystal molecules sandwiched between the pixel electrode and the common electrode. The pixel electrode is electrically coupled to a corresponding scan line 110 and a corresponding data line 120 through a corresponding transistor (such as a thin-film transistor). Thus the corresponding transistor is turned on when the scan signal of the corresponding scan line 110 is in a scan period such that the image-displaying data is transmitted to the corresponding pixel electrode for making the corresponding display pixel 130 display the image-displaying data.

In addition, parts of the display pixels 130 (such as, the display pixels indicated by label 131) are not only used as the display pixels for displaying the corresponding image-displaying data respectively, but also used as touch pixels for performing a touch-detecting operation respectively. That is, each of the touch pixels 131 further comprises a corresponding touch sensor except of the elements for forming each of the display pixels.

When the touch pixels 131 are enabled by scan signals of corresponding scan lines 110 and in corresponding scan periods respectively, they receive touch-charging data from corresponding data lines 120 respectively. Thus the touch pixels 131 perform the touch-detecting operation respectively, to determine whether the corresponding touch pixels 131 are touched. That is, the touch sensor of each of the touch pixels 131 is enabled by a scan signal of a corresponding scan line 110, and receives the touch-charging data from a corresponding data line 120 to perform the touch-detecting operation.

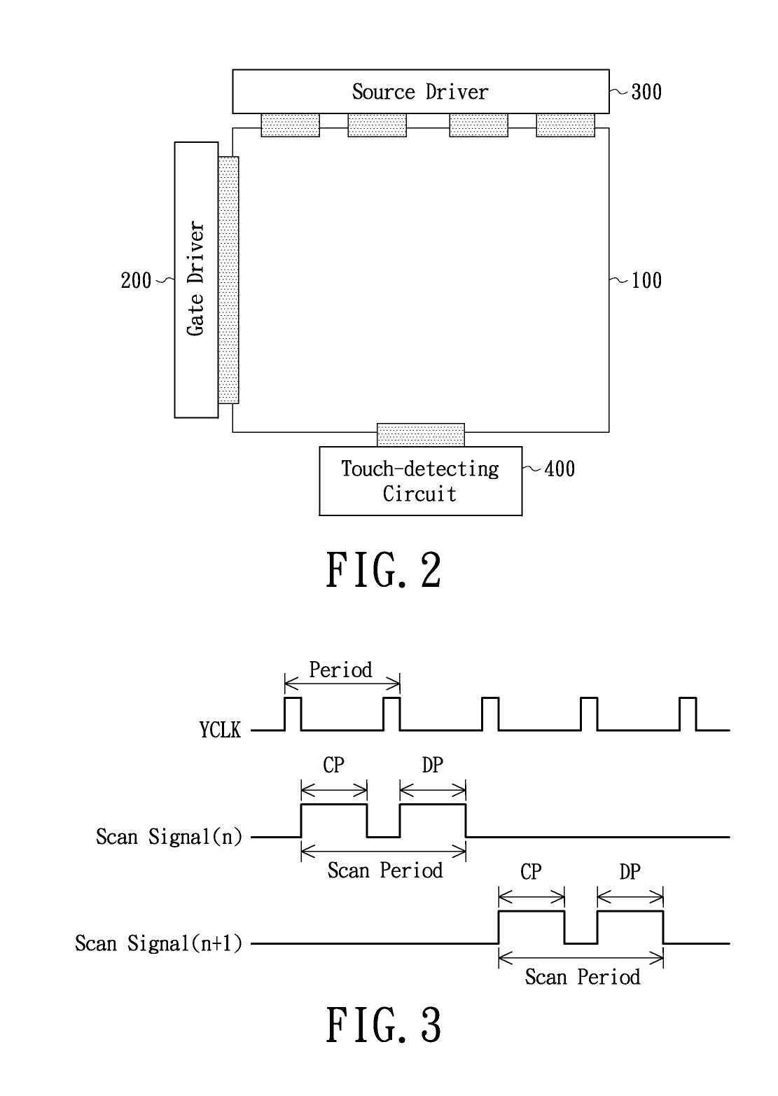

FIG. 2 is a schematic view of a circuit, in which is the display panel as shown in FIG. 1 applied. Referring to FIG. 2, the display panel 100 is electrically coupled to a gate driver 200 and a source driver 300 respectively. The gate driver 200 is configured for providing the scan signals to the scan lines (not shown) of the display panel 100 in sequence, and the source driver 300 is configured for providing the image-displaying data to the data lines (not shown) of the display panel 100 respectively. In addition, the source driver 300 is also configured for providing the touch-charging data to the data lines of the display panel 100, such that when a scan signal of a scan line 110 is enabled and in the scan period, the touch-charging data is provided to the corresponding touch pixels through the corresponding data lines 120 and generates corresponding touch-detecting signals respectively. Furthermore, the display panel 100 is also electrically coupled to a touch-detecting circuit 400 for transmitting the touch-detecting signals to the touch-detecting circuit 400. The touch-detecting circuit 400 judges whether the touch pixels are touched according to the touch-detecting signals. In the exemplary embodiment, the touch-detecting circuit 400 may be electrically coupled to the data lines 120 of the display panel 100 as shown in FIG. 1, such that the generated touch-detecting signals are transmitted to the touch-detecting circuit 400 through the corresponding data lines 120, for judging whether the touch pixels 131 are touched. It is understood for persons skilled in the art that, the gate driver 200, the source driver 300 and the touch-detecting circuit 400 may employ the conventional art to be electrically coupled to the display panel 100 respectively. For example, it may employ flexible circuit boards to electrically coupling the gate driver 200, the source driver 300 and the touch-detecting circuit 400 to the display panel 100 respectively.

FIG. 3 is a time-sequence view of various signals of the display panel as shown in FIG. 1. Referring to FIG. 3, the scan signal in each of the scan lines 110 of the display panel 100 of the disclosure has a corresponding scan period, which corresponds to two periods of a clock signal YCLK. The scan period of each scan signal is divided into a touch period CP and a display period DP, and each of the touch period CP and the display period DP corresponds to a period of the clock signal YCLK. Preferably, the touch period CP may be designed before the display period DP. That is, the touch pixels 131 corresponding to each of the scan lines 110 of the display panel 100 firstly perform the touch-detecting operation, and then the display pixels 130 (comprising the touch pixels 131) corresponding to the each of the scan lines 110 perform the displaying operation.

For example, for the n-th scan line 110, when the corresponding scan signal (n) is enabled and in the touch-detecting period CP of the corresponding scan period (that is, in the previous period of the two corresponding periods of the clock signal YCLK), the source driver 300 may provide touch-charging data to a corresponding touch pixel 131 through a corresponding data line 120. The touch-charging data generates the corresponding touch-detecting signal in the corresponding data line 120. In detail, the source driver 300 provides the charges with the constant amount to the corresponding data line 120 in the touch-detecting period CP, and it will alter the potential of the corresponding data line 120 according to whether being touched by the user. Therefore, it may detect the data line 120 in the touch-detecting period CP to obtain the touch-detecting signal.

Herein, since there may be a plurality of touch pixels 131 corresponding to the n-th scan line 110, the source driver 300 may simultaneously provide the touch-charging data to the corresponding touch pixels 131 through the different corresponding data lines 120 respectively. That is, the touch pixels 131 corresponding to the n-th scan line 110 are turned on simultaneously to perform the touch-detecting operation respectively. Of course, it is understood for persons skilled in the art that, the source driver 300 may also provide the touch-charging data to the corresponding touch pixels 131 in sequence in the touch-detecting period CP. That is, the touch pixels 131 corresponding to the n-th scan line 110 are turned on in sequence to perform the touch-detecting operation respectively.

Furthermore, for the n-th scan line, when the corresponding scan signal (n) is enabled and in the display period of the scan period (that is, in the later period of the two corresponding periods of the clock signal YCLK), the source driver 300 provides image-displaying data to the corresponding display pixels 130 (comprising the corresponding touch pixels 131) through the corresponding data lines 120, such that the corresponding display pixels 130 perform the displaying operation.

After the scan signal (n) of the n-th scan line 110 is enabled to perform the touch-detecting operation and the displaying operation, the scan signal (n+1) of the (n+1)-th scan line 110 starts enabling according to the clock signal YCLK, to perform the touch-detecting operation and the displaying operation. Therefore, the clock signal YCLK applied into the display panel 100 of the disclosure is double of the clock signal applied into the general display panel. For example, if the general display panel uses the clock signal with the frequency of 60 Hz, the display panel 100 of the disclosure uses the clock signal YCLK with the frequency of 120 Hz.

In addition, it is understood for persons skilled in the art that, the sequence of the touch-detecting period CP and the display period DP is not limited since the color and the luminance seen by the eyes of the users is accumulated. Therefore, it may be also designed that the touch-detecting period CP is after the display period DP in the corresponding scan period when the scan signal of each of the scan lines 110 is enabled. That is, the display pixels 130 (comprising the corresponding touch pixels 131) corresponding to each of the scan lines 110 of the display panel 110 firstly perform the displaying operation, and then the touch pixels 131 corresponding to each of the scan lines 110 perform the touch-detecting operation. The sequence does not influence the final display result, and the potentials of the data should be adjusted depending on actual conditions.

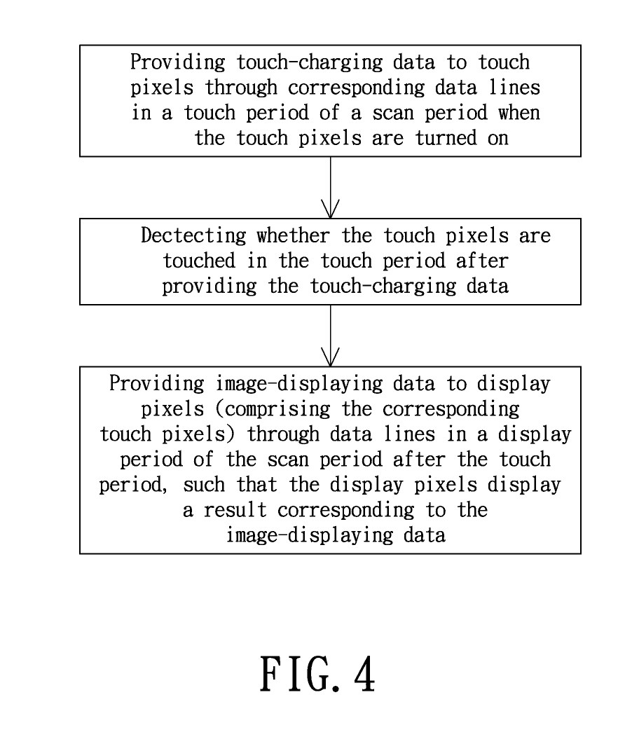

FIG. 4 is a flow chart of an operation method of a display panel in accordance with another exemplary embodiment of the disclosure. The display panel may be the display panel as shown in FIGS. 1-3. Referring to FIGS. 1-4, the operation method comprises: providing touch-charging data to touch pixels through corresponding data lines respectively in a touch-detecting period CP of a scan period when the touch pixels are turned on; detecting whether the touch pixels are touched in the touch-detecting period CP after providing the touch-charging data; and providing image-displaying data to display pixels (comprising some of the display pixels used as the touch pixels) through data lines in a display period DP after the touch-detecting period CP, such that the display pixels display a result corresponding to the image-displaying data.

In addition, although the touch-detecting circuit 400 obtains the touch-detecting signals through the corresponding data lines 120 of the display panel 100 in the above exemplary embodiment, it is understood for persons skilled in the art that, the disclosure may also dispose corresponding readout lines in the display panel 100, and the readout lines are electrically coupled between the touch pixels 131 and the touch-detecting circuit 400 respectively. Therefore, the touch-detecting circuit 400 can read out touch-detecting signals through the corresponding readout lines to judge whether the touch pixels 131 are touched.

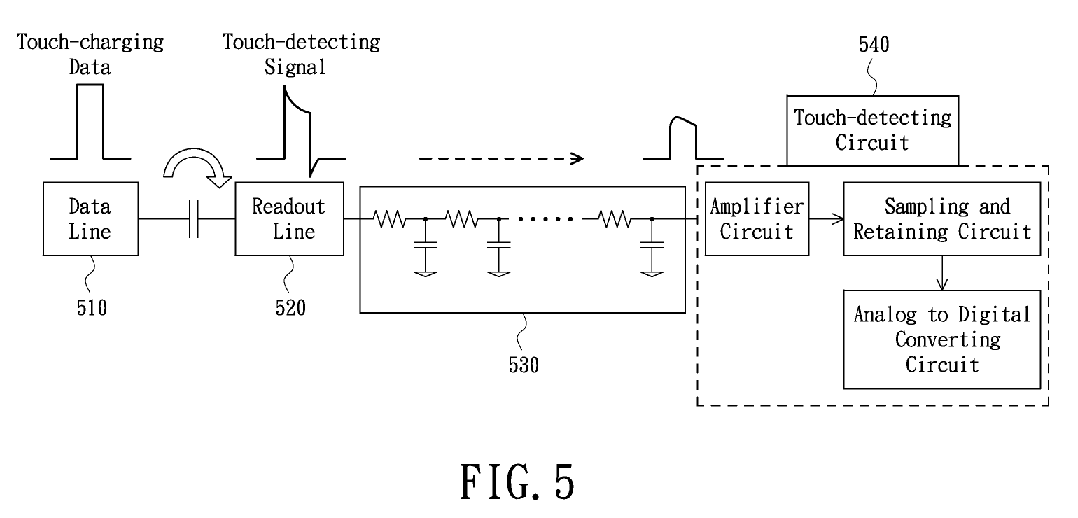

FIG. 5 is a circuit schematic view of performing a touch-detecting operation and reading out a touch-detecting signal in accordance with other exemplary embodiment of the disclosure. As shown in FIG. 5, a corresponding data line 510 of the display panel is used as a driving line and provides touch-charging data to a corresponding touch pixel in a touch-detecting period, and a corresponding touch-detecting signal is generated according to whether the corresponding touch pixel is touched. Then, the corresponding readout line 520 transmits the touch-detecting signal, and the touch-detecting signal is transmitted to the touch-detecting circuit 540 through certain line parasitic impedance 530. It is understood for persons skilled in the art that, the touch-detecting circuit 540 may comprises an amplifier circuit, a sampling and retaining circuit and an analog to digital converting circuit, to analyze the touch-detecting signal transmitted from the readout line 520, for judging whether the corresponding touch pixel is touched.

In summary, the display panel and the operation method of the disclosure employs the source driver to provide the touch-charging data to the corresponding touch pixels through the corresponding data lines, and it will not dispose a specific driving module and driving lines to provide the touch-charging data, thus the circuit of the disclosure is simple, and can reduce the related signal interference. Furthermore, since the driving capability of the source driver is powerful, the disclosure may design more touch pixels, and the maximum amount of the touch pixels may reach the amount of the display pixels of the whole display panel. That is, all of the display pixels of the display panel of the disclosure may be not only used as the display pixels for performing the displaying operation, but also used as the touch pixels for performing the touch-detecting operation.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A display panel, comprising:
a plurality of scan lines, each thereof being enabled for a scan period in sequence;
a plurality of data lines; and
a plurality of display pixels, each of the display pixels being electrically coupled to a corresponding one of the scan lines and a corresponding one of the data lines respectively, and each of the display pixels being controlled by the corresponding one of the scan lines to determine whether receiving data provided from the corresponding one of the data lines;
wherein at least one of the display pixels is also used as a touch pixel for performing a touch-detecting operation, the scan period is divided into a touch period and a display period, a data line corresponding to the touch pixel provides touch-charging data to the touch pixel in the touch period for generating a corresponding touch-detecting signal, and provides image-displaying data to the touch pixel in the display period, the corresponding touch-detecting signal is configured for judging whether the touch pixel is touched.

2. The display panel according to claim 1, wherein all of the display pixels are also used as touch pixels for performing the touch-detecting operation

3. The display panel according to claim 1, wherein some of the display pixels are also used as touch pixels for performing the touch-detecting operation.

4. The display panel according to claim 1, wherein the touch period is before the display period.

5. The display panel according to claim 1, wherein the touch period is after the display period.

6. The display panel according to claim 1, further comprising a touch-detecting circuit, wherein the touch-detecting circuit reads out the corresponding touch-detecting signal through the touch data line for judging whether the corresponding touch pixel is touched.

7. The display panel according to claim 1, further comprising a touch-detecting circuit, wherein the touch-detecting circuit reads out the corresponding touch-detecting signal through a corresponding readout line for judging whether the corresponding touch pixel is touched.

8. An operation method for a display panel, the display panel comprising at least one pixel and at least one data line corresponding to the at least one pixel respectively, the pixel being used for performing both of a displaying operation and performing a touch-detecting operation, and the operation method comprising:
providing touch-charging data to the pixel through the data line for performing the touch-detecting operation to generate a corresponding touch-detecting signal in a touch period of a scan period when the pixel is turned on;
detecting the corresponding touch-detecting signal to judging whether the pixel is touched after providing the touch-charging data; and
providing image-displaying data to the pixel through the data line in a display period of the scan period, such that the pixel displays a result corresponding to the image-displaying data.

9. The operation method according to claim 8, wherein the touch period and the display period are both a half of the scan period.

10. The operation method according to claim 8, wherein the display panel further comprises a scan line to turn on the pixel in the scan period.
